(19) United States
(12) Patent Application Publication
(10) Pub. No.: US 2021/0334423 A1
(43) Pub. Date: Oct. 28, 2021

(54) METHOD FOR CALCULATION OF NATURAL FREQUENCY OF MULTI-SEGMENT CONTINUOUS BEAM

(71) Applicant: SUZHOU UNIVERSITY OF SCIENCE AND TECHNOLOGY, Suzhou (CN)

(72) Inventors: Siyuan Bao, Suzhou (CN); Jing Zhou, Suzhou (CN)

(21) Appl. No.: 17/152,247

(22) Filed: Jan. 19, 2021

(30) Foreign Application Priority Data
Apr. 27, 2020 (CN) 202010343754.2

(51) Int. Cl. G06F 30/13; G06F 30/17; G06F 30/23; G01M 5/00

(52) U.S. Cl. CPC G06F 30/13; G06F 30/17; G01M 5/0033; G01M 5/0066; G06F 30/23

(57) ABSTRACT

A displacement spring and a rotational spring are arranged on both ends of the multi-segment continuous beam to simulate arbitrary boundary conditions, and a lateral displacement function of the multi-segment continuous beam over a whole segment is constructed. A strain energy, an elastic potential energy of simulated springs at a boundary, a maximum value of a kinetic energy, and a Lagrangian function of the multi-segment continuous beam are calculated. The improved Fourier series of the displacement function is substituted into the Lagrange function. An extreme value of each undetermined coefficient in the improved Fourier series in the Lagrangian function is taken to obtain a system of homogeneous linear equations which is further converted into a matrix. An eigenvalue problem of the standard matrix is solved for to obtain the natural frequency.

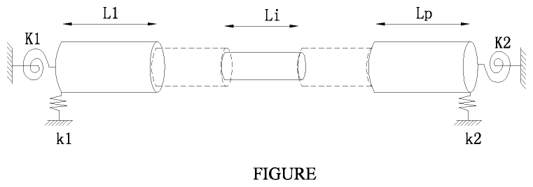

### CROSS-REFERENCE TO RELATED APPLICATIONS

This application claims the benefit of priority from Chinese Patent Application No. 202010343754.2, filed on Apr. 27, 2020. The content of the aforementioned application, including any intervening amendments thereto, is incorporated herein by reference in its entirety.

### TECHNICAL FIELD

The present application relates to beam structures, and more particularly to a method for calculation of a natural frequency of a multi-segment continuous beam.

### BACKGROUND

Multi-segment continuous beams are defined as stepped rods with bending as the main deformation, and multi-segment beam components are widely applied in engineering, such as stepped shafts for supporting rotating parts and transmitting motion and power in power machinery, stepped drill strings and oil rods in oil drilling engineering, stepped piston rods in engines, and workpieces in turning. The vibration of the continuous beams is a basic subject in mechanical vibration, and natural frequencies of the multi-segment continuous beams are affected by multiple factors, such as cross-sectional shapes, lengths of segmented rods, materials, and lengths of beams. The existing literatures have provided natural frequency equations of straight rods with a constant cross-section under conventional classical boundary conditions (such as clamped constrain, simply supported constrain, free boundary), so that the natural frequency value can be obtained by solving the corresponding equations. However, under a given boundary condition, in order to determine the natural frequency of a multi-segment continuous beam, the corresponding frequency equations are relatively complicated, and a large amount of calculation is required. For the calculation of bending vibration of two-segment stepped beams, there is no systematic derivation and calculation of the natural frequency of bending vibration of stepped multi-segment beams in the existing literatures. At the same time, the applicable formula for calculating the natural frequency of the bending of the stepped multi-segment beam under given elastic boundary conditions is not found. Therefore, it is necessary to provide a method for calculation of a natural frequency of bending vibrations of each order of the multi-segment continuous beam.

### SUMMARY

In order to solve the above-mentioned technical defects, the present disclosure provides a method for calculation of a natural frequency of a multi-segment continuous beam. The derivation and the calculation of the natural frequency of the multi-segment continuous beam under an elastic boundary condition are performed, which can quickly obtain the multi-order natural frequencies of bending of a multi-segment beam, where multiple segments of the multi-segment beam have different cross-sectional shapes, different materials and different lengths. Thus, the method of the present disclosure is easy to popularize and use.

To achieve the above-mentioned object, the present disclosure provides a method for calculation of a natural frequency of a multi-segment continuous beam, comprising:

(1) arranging a displacement spring and a rotational spring on each of a first end and a right end of the multi-segment continuous beam to simulate arbitrary boundary conditions;

(2) constructing a lateral displacement function of the multi-segment continuous beam over a full length thereof, and expressing the lateral displacement function in a form of an improved Fourier series, wherein the improved Fourier series is formed by adding four auxiliary functions into a classic Fourier series;

(3) calculating a strain energy of the multi-segment continuous beam;

(4) calculating an elastic potential energy of the displacement spring and the rotational spring at a boundary of the multi-segment continuous beam;

(5) calculating a maximum value of a kinetic energy of the multi-segment continuous beam;

(6) calculating the Lagrangian function of the multi-segment continuous beam;

(7) substituting the improved Fourier series of the lateral displacement function into the Lagrange function;

(8) taking an extreme value of each of undetermined coefficients in the improved Fourier series in the Lagrangian function to let a partial derivative be zero, so as to obtain a system of homogeneous linear equations;

(9) converting the system of homogeneous linear equations obtained into a matrix form; and

(10) solving for an eigenvalue problem of the matrix to obtain a natural frequency of each order of the multi-segment continuous beam.

In an embodiment, in step (1), a stiffness value of the displacement spring and a stiffness value of the rotational spring stiffness at one boundary are respectively denoted as k₁ and K₁, and a stiffness value of the displacement spring and a stiffness value of the rotational spring at the other boundary are respectively denoted as k₂ and K₂; when the boundary is a clamped boundary, the stiffness value of the displacement spring and the stiffness value of the rotational spring need to be set to infinity at the same time, and the stiffness value of the displacement spring and the stiffness value of the rotational spring are set to 10¹³, respectively; when the boundary is a free boundary, the stiffness value of the displacement spring and the stiffness value of the rotational spring are set to zero; when the boundary is a simply supported boundary, the stiffness value of the displacement spring is set to 10¹³, and the stiffness value of the rotational spring is 0; and when the stiffness value of the displacement spring and the stiffness value of the rotational spring are finite values, an elastic constraint boundary condition is simulated.

In an embodiment, the lateral displacement function of the multi-segment continuous beam over a whole segment expressed in the form of the improved Fourier series in step (2) is:

$$W ( x ) = {\sum }_{n = 0}^{9} {a}_{n} cos ( {λ}_{n} x ) + {\sum }_{n = - 4}^{- 1} {a}_{n} sin ( {λ}_{n} x ) ; \qquad ( 1 )$$

wherein x ∈[0,L]; aₙ is an undetermined constant; and λₙ=nπ/L

In an embodiment, the strain energy of the multi-segment continuous beam structure in step (3) is:

$${V}_{P} = \frac{1}{2} {E}_{1} {I}_{1} {\int }_{0}^{{L}_{1}} {( \frac{{d}^{2} w}{{dx}^{2}} )}^{2} dx + \frac{1}{2} {\sum }_{i = 2}^{i = p} {E}_{i} {I}_{i} {\int }_{{L}_{1} + {L}_{2} … {L}_{i - 1}}^{{L}_{1} + {L}_{2} … {L}_{i}} {( \frac{{d}^{2} w}{d {x}^{2}} )}^{2} dx ; \qquad ( 2 )$$

wherein a total length of the multi-segment continuous beam is L; the multi-segment continuous beam is divided into p segments; a length of an i-th segment is Lᵢ; Vp is the strain energy of the multi-segment continuous beam under arbitrary boundary conditions; Eᵢ is an elastic modulus of the i-th segment, and Iᵢ is a moment of inertia of a cross section of the i-th segment.

In an embodiment, the elastic potential energy Vs of the displacement spring and the rotational spring at the boundary of the multi-segment continuous beam in step (4) is:

$${V}_{s} = \frac{1}{2} ( {k}_{1} {w}^{2} {\vert}_{x = 0} + {{K}_{1} ( \frac{\partial w}{\partial x} )}^{2} {\vert}_{x = 0} + {k}_{2} {w}^{2} {\vert}_{x = L} + {{K}_{2} ( \frac{\partial w}{\partial x} )}^{2} {\vert}_{x = L} ) . \qquad ( 3 )$$

In an embodiment, a form of a modal solution of the multi-segment continuous beam is assumed based on a variable separation method in step (2) as:

w(x,t)=W(x)e^{iwt} (4);

wherein i is an imaginary unit, and w is the natural frequency of the multi-segment continuous beam.

In an embodiment, the maximum value of the kinetic energy of the multi-segment continuous beam in step (5) is:

$${T}_{max} = \frac{1}{2} ρ ( x ) {\int }_{0}^{L} S ( x ) {( \frac{d w}{d t} )}^{2} d x = \frac{{ω}^{2}}{2} {\int }_{0}^{L} ρ ( x ) S ( x ) {w}^{2} d x . \qquad ( 5 )$$

In an embodiment, the Lagrangian function of the multi-segment continuous beam in step (6) is:

$$L = {V}_{max} - {T}_{max} = {V}_{p} + {V}_{s} - {T}_{max} . \qquad ( 6 )$$

In an embodiment, in step (8), the partial derivative of the undermined coefficient aₙ (n=−4, −3, . . . , 9) is calculated item by item in the Lagrangian function, to obtain the system of homogeneous linear equations:

[(M₁+ . . . +Mₚ)ω²−(Kp₁+ . . . +Kpₚ+Ks₁+Ks₂+Ks₃+Ks₄)]A=0 (7);

wherein A={a₋₄, a₋₃, . . . , a₈, a₉}^{T},

$${Kp}_{1} = {E}_{1} {I}_{1} [ \begin{matrix}{\int }_{0}^{{L}_{1}} \frac{{d}^{2} {f}_{1}}{{dx}^{2}} \frac{{d}^{2} {f}_{1}}{{dx}^{2}} dx & {\int }_{0}^{{L}_{1}} \frac{{d}^{2} {f}_{1}}{{dx}^{2}} \frac{{d}^{2} {f}_{2}}{{dx}^{2}} dx & … & {\int }_{0}^{{L}_{1}} \frac{{d}^{2} {f}_{1}}{{dx}^{2}} \frac{{d}^{2} {f}_{m}}{{dx}^{2}} dx \\ {\int }_{0}^{{L}_{1}} \frac{{d}^{2} {f}_{2}}{{dx}^{2}} \frac{{d}^{2} {f}_{1}}{{dx}^{2}} dx & {\int }_{0}^{{L}_{1}} \frac{{d}^{2} {f}_{2}}{{dx}^{2}} \frac{{d}^{2} {f}_{2}}{{dx}^{2}} dx & … & {\int }_{0}^{{L}_{1}} \frac{{d}^{2} {f}_{2}}{{dx}^{2}} \frac{{d}^{2} {f}_{m}}{{dx}^{2}} dx \\ ⋮ & ⋮ & ⋮ & ⋮ \\ {\int }_{0}^{{L}_{1}} \frac{{d}^{2} {f}_{m}}{{dx}^{2}} \frac{{d}^{2} {f}_{1}}{{dx}^{2}} dx & {\int }_{0}^{{L}_{1}} \frac{{d}^{2} {f}_{m}}{{dx}^{2}} \frac{{d}^{2} {f}_{2}}{{dx}^{2}} dx & … & {\int }_{0}^{{L}_{1}} \frac{{d}^{2} {f}_{m}}{{dx}^{2}} \frac{{d}^{2} {f}_{m}}{{dx}^{2}} dx\end{matrix} ] , \\ …$$

$$K {p}_{p} = {E}_{p} {I}_{p} [ \begin{matrix}{\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{m}}{{dx}^{2}} dx \\ {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{m}}{{dx}^{2}} dx \\ ⋮ & ⋮ & ⋮ & ⋮ \\ {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{m}}{{dx}^{2}} dx\end{matrix} ]$$

$$K {p}_{p} = {E}_{p} {I}_{p} [ \begin{matrix}{\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{m}}{{dx}^{2}} dx \\ {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{m}}{{dx}^{2}} dx \\ ⋮ & ⋮ & ⋮ & ⋮ \\ {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{m}}{{dx}^{2}} dx\end{matrix} ]$$

$${M}_{1} = {ρ}_{1} {A}_{1} [ \begin{matrix}{\int }_{0}^{{L}_{1}} {f}_{1} {f}_{1} dx & {\int }_{0}^{{L}_{1}} {f}_{1} {f}_{2} dx & … & {\int }_{0}^{{L}_{1}} {f}_{1} {f}_{m} dx \\ {\int }_{0}^{{L}_{1}} {f}_{2} {f}_{1} dx & {\int }_{0}^{{L}_{1}} {f}_{2} {f}_{2} dx & … & {\int }_{0}^{{L}_{1}} {f}_{2} {f}_{m} dx \\ ⋮ & ⋮ & ⋮ & ⋮ \\ {\int }_{0}^{{L}_{1}} {f}_{m} {f}_{1} dx & {\int }_{0}^{{L}_{1}} {f}_{m} {f}_{2} dx & … & {\int }_{0}^{{L}_{1}} {f}_{m} {f}_{m} dx\end{matrix} ] , \\ …$$

$${M}_{p} = {ρ}_{p} {A}_{p} [ \begin{matrix}{\int }_{{L}_{1} + {L}_{2} … {L}_{i - 1}}^{{L}_{1} + {L}_{2} … {L}_{i}} {f}_{1} {f}_{1} d x & {\int }_{{L}_{1} + {L}_{2} … {L}_{i - 1}}^{{L}_{1} + {L}_{2} … {L}_{i}} {f}_{1} {f}_{2} d x & … & {\int }_{{L}_{1} + {L}_{2} … {L}_{i - 1}}^{{L}_{1} + {L}_{2} … {L}_{i}} {f}_{1} {f}_{m} d x \\ {\int }_{{L}_{1} + {L}_{2} … {L}_{i - 1}}^{{L}_{1} + {L}_{2} … {L}_{i}} {f}_{2} {f}_{1} dx & {\int }_{{L}_{1} + {L}_{2} … {L}_{i - 1}}^{{L}_{1} + {L}_{2} … {L}_{i}} {f}_{2} {f}_{2} d x & … & {\int }_{{L}_{1} + {L}_{2} … {L}_{i - 1}}^{{L}_{1} + {L}_{2} … {L}_{i}} {f}_{2} {f}_{m} d x \\ ⋮ & ⋮ & ⋮ & ⋮ \\ {\int }_{{L}_{1} + {L}_{2} … {L}_{i - 1}}^{{L}_{1} + {L}_{2} … {L}_{i}} {f}_{m} {f}_{1} d x & {\int }_{{L}_{1} + {L}_{2} … {L}_{i - 1}}^{{L}_{1} + {L}_{2} … {L}_{i}} {f}_{m} {f}_{2} d x & … & {\int }_{{L}_{1} + {L}_{2} … {L}_{i - 1}}^{{L}_{1} + {L}_{2} … {L}_{i}} {f}_{m} {f}_{m} d x\end{matrix} ] .$$

In an embodiment, a condition for the system of the homogeneous linear equations to have a nontrivial solution in the step (8) is: a value of coefficient determinant of the system of the homogeneous linear equations is zero, to obtain a frequency equation.

Compared to the prior art, the present invention has following beneficial effects.

The method of the present invention can realize systematical derivation and calculation of the natural frequency of the multi-segment continuous beam under an elastic boundary condition. Based on this method, the natural frequencies of the multi-segment beam can be quickly obtained when multiple segments of the multi-segment beam have different cross-sectional shapes, different materials and different lengths. Therefore, the method of the present invention has broad application prospects.

### BRIEF DESCRIPTION OF THE DRAWINGS

The present disclosure will be further described in detail in conjunction with the accompanying drawings.

The figure is a schematic diagram of a multi-segment continuous beam model under arbitrary boundary conditions according to an embodiment of the present disclosure.

### DETAILED DESCRIPTION OF EMBODIMENTS

In order to make the technical means, inventive features, objectives and effects of the present disclosure easy to understand, the present disclosure will be further illustrated below in conjunction with specific embodiments.

As shown in the figure, the embodiment provides a method for calculation of a natural frequency of a multi-segment continuous beam, including the following steps.

(1) A displacement spring and a rotational spring are arranged on each of a left end and a right end of the multi-segment continuous beam to simulate arbitrary boundary conditions.

(2) A lateral displacement function of the multi-segment continuous beam over a whole segment is constructed and consists of an undetermined mode shape function and an exponential function of an undetermined vibration frequency. The undetermined mode shape function is expressed in a form of an improved Fourier series, where the improved Fourier series is formed by adding four auxiliary functions into a classic Fourier series.

(3) A strain energy of the multi-segment continuous beam is calculated. The multi-segment continuous beam is a straight rod, such as Bernoulli-Euler beams.

(4) An elastic potential energy of simulated springs at a boundary of the multi-segment continuous beam is calculated.

(5) A maximum value of a kinetic energy of the multi-segment continuous beam is calculated.

(6) A Lagrangian function of the multi-segment continuous beam is calculated.

(7) The improved Fourier series of the lateral displacement function is substituted into the Lagrange function.

(8) An extreme value of each undetermined coefficient in the improved Fourier series in the Lagrangian function is taken to let a partial derivative be zero, so as to obtain a system of homogeneous linear equations.

(9) The system of homogeneous linear equations is converted into a matrix form.

(10) An eigenvalue problem of the standard matrix is solved for through Mathematica, to obtain a natural angular frequency of each order of the multi-segment continuous beam.

In step (1), a stiffness value of the displacement spring and a stiffness value of the rotational spring at a left boundary are respectively denoted as k1 and K₁, and a stiffness value of the displacement spring and a stiffness value of the rotational spring at a right boundary are respectively denoted as k₂ and K₂. When the boundary is a clamped boundary, the stiffness value of the displacement spring and the stiffness value of the rotational spring need to be set to infinity at the same time, and the stiffness value of the displacement spring and the stiffness value of the rotational spring are set to 10¹³, respectively. When the boundary is a free boundary, the stiffness value of the displacement spring and the stiffness value of the rotational spring can be set to zero. When the boundary is a simply supported boundary, the stiffness value of the displacement spring is set to 10¹³, and the stiffness value of the rotational spring is set to 0. When the stiffness value of the displacement spring and the stiffness value of the rotational spring are finite values, an elastic constraint boundary condition can be simulated.

A form of a modal solution of the multi-segment continuous beam is assumed based on a variable separation method as:

w(x,t)=W(x)e^{iwt} (4);

where i is an imaginary unit; W(x) is the vibrational model function; and co is the natural frequency of the multi-segment continuous beam.

The vibrational model function W(x) is expressed in a form as follows:

$$W ( x ) = {\sum }_{n = 0}^{9} {a}_{n} cos ( {λ}_{n} x ) + {\sum }_{n = - 4}^{- 1} {a}_{n} sin ( {λ}_{n} x ) ; \qquad ( 1 )$$

where x ∈[0,L]; aₙ(n=−4, −3, . . . , 9) is an undetermined constant; and λₙ=nπ/L.

The strain energy of the multi-segment continuous beam consists of strain energies of segments of the multi-segment continuous beam and is expressed as:

$${V}_{P} = \frac{1}{2} {E}_{1} {I}_{1} {\int }_{0}^{{L}_{1}} {( \frac{{d}^{2} w}{{dx}^{2}} )}^{2} dx + \frac{1}{2} {\sum }_{i = 2}^{i = p} {E}_{i} {I}_{i} {\int }_{{L}_{1} + {L}_{2} … {L}_{i - 1}}^{{L}_{1} + {L}_{2} … {L}_{i}} {( \frac{{d}^{2} w}{d {x}^{2}} )}^{2} dx ; \qquad ( 2 )$$

the strain energy of each segment of the multi-segment continuous beam is expressed as:

$${V}_{P 1} = \frac{1}{2} {E}_{1} {I}_{1} {\int }_{0}^{{L}_{1}} {( \frac{{d}^{2} w}{{dx}^{2}} )}^{2} d x \\ {V}_{P 2} = \frac{1}{2} {E}_{2} {I}_{2} {\int }_{{L}_{1}}^{{L}_{1} + {L}_{2}} {( \frac{{d}^{2} w}{d {x}^{2}} )}^{2} d x ;$$

$$…$$

where a total length of the multi-segment continuous beam is L; the multi-segment continuous beam is divided into p segments; and a length of the i-th segment is Li; Vp is the strain energy of the multi-segment continuous beam under arbitrary boundary conditions; Ei is an elastic modulus of the i-th segment, and is a moment of inertia of of a cross section of the i-th segment.

The elastic potential energy Vs of the simulated spring at the boundary of the multi-segment continuous beam is:

$${V}_{s} = \frac{1}{2} ( {k}_{1} {w}^{2} {\vert}_{x = 0} + {{K}_{1} ( \frac{\partial w}{\partial x} )}^{2} {\vert}_{x = 0} + {k}_{2} {w}^{2} {\vert}_{x = L} + {{K}_{2} ( \frac{\partial w}{\partial x} )}^{2} {\vert}_{x = L} ) . \qquad ( 3 )$$

The maximum kinetic energy of the multi-segment continuous beam is:

$${T}_{max} = \frac{1}{2} ρ ( x ) {\int }_{0}^{L} S ( x ) {( \frac{d w}{d t} )}^{2} d x = \frac{{ω}^{2}}{2} {\int }_{0}^{L} ρ ( x ) S ( x ) {w}^{2} d x . \qquad ( 5 )$$

The Lagrangian function of the multi-segment continuous beam is:

L=Vₘₐₓ−T_{max=V}_{ₚ}_{+V}_{ₛ}_{-T}_{ₘₐₓ} (6).

The partial derivative of the undetermined coefficient an (n=−4, −3, . . . , 9) is calculated item by item in the Lagrangian function to obtain the system of homogeneous linear equations:

[(M₁+ . . . +Mₚ)ω²(Kp₁+ . . . +Kpₚ+Ks₁+Ks₂+Ks₃+Ks₄)]A=0 (7);

where A={a₋₄, a₋₃, . . . , a₈, a₉}^{T},

$${Kp}_{1} = {E}_{1} {I}_{1} [ \begin{matrix}{\int }_{0}^{{L}_{1}} \frac{{d}^{2} {f}_{1}}{{dx}^{2}} \frac{{d}^{2} {f}_{1}}{{dx}^{2}} dx & {\int }_{0}^{{L}_{1}} \frac{{d}^{2} {f}_{1}}{{dx}^{2}} \frac{{d}^{2} {f}_{2}}{{dx}^{2}} dx & … & {\int }_{0}^{{L}_{1}} \frac{{d}^{2} {f}_{1}}{{dx}^{2}} \frac{{d}^{2} {f}_{m}}{{dx}^{2}} dx \\ {\int }_{0}^{{L}_{1}} \frac{{d}^{2} {f}_{2}}{{dx}^{2}} \frac{{d}^{2} {f}_{1}}{{dx}^{2}} dx & {\int }_{0}^{{L}_{1}} \frac{{d}^{2} {f}_{2}}{{dx}^{2}} \frac{{d}^{2} {f}_{2}}{{dx}^{2}} dx & … & {\int }_{0}^{{L}_{1}} \frac{{d}^{2} {f}_{2}}{{dx}^{2}} \frac{{d}^{2} {f}_{m}}{{dx}^{2}} dx \\ ⋮ & ⋮ & ⋮ & ⋮ \\ {\int }_{0}^{{L}_{1}} \frac{{d}^{2} {f}_{m}}{{dx}^{2}} \frac{{d}^{2} {f}_{1}}{{dx}^{2}} dx & {\int }_{0}^{{L}_{1}} \frac{{d}^{2} {f}_{m}}{{dx}^{2}} \frac{{d}^{2} {f}_{2}}{{dx}^{2}} dx & … & {\int }_{0}^{{L}_{1}} \frac{{d}^{2} {f}_{m}}{{dx}^{2}} \frac{{d}^{2} {f}_{m}}{{dx}^{2}} dx\end{matrix} ] , \\ …$$

$$K {p}_{p} = {E}_{p} {I}_{p} [ \begin{matrix}{\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{m}}{{dx}^{2}} dx \\ {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{m}}{{dx}^{2}} dx \\ ⋮ & ⋮ & ⋮ & ⋮ \\ {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{m}}{{dx}^{2}} dx\end{matrix} ]$$

$${Ks}_{1} = {{k}_{1} [ \begin{matrix}{f}_{1} {f}_{1} & {f}_{1} {f}_{2} & … & {f}_{1} {f}_{m} \\ {f}_{1} {f}_{2} & {f}_{2} {f}_{2} & … & {f}_{2} {f}_{m} \\ ⋮ & ⋮ & ⋮ & ⋮ \\ {f}_{1} {f}_{m} & {f}_{2} {f}_{m} & … & {f}_{m} {f}_{n}\end{matrix} ]}_{x = 0} , {Ks}_{2} = {{k}_{2} [ \begin{matrix}{f}_{1} {f}_{1} & {f}_{1} {f}_{2} & … & {f}_{1} {f}_{m} \\ {f}_{1} {f}_{2} & {f}_{2} {f}_{2} & … & {f}_{2} {f}_{m} \\ ⋮ & ⋮ & ⋮ & ⋮ \\ {f}_{1} {f}_{m} & {f}_{2} {f}_{m} & … & {f}_{m} {f}_{n}\end{matrix} ]}_{x = L} , \\ {Ks}_{3} = {{K}_{1} [ \begin{matrix}\frac{{df}_{1}}{dx} \frac{{df}_{1}}{dx} & \frac{{df}_{1}}{dx} \frac{{df}_{2}}{dx} & … & \frac{{df}_{1}}{dx} \frac{{df}_{m}}{dx} \\ \frac{{df}_{1}}{dx} \frac{{df}_{2}}{dx} & \frac{{df}_{2}}{dx} \frac{{df}_{2}}{dx} & … & \frac{{df}_{2}}{dx} \frac{{df}_{m}}{dx} \\ ⋮ & ⋮ & ⋮ & ⋮ \\ \frac{{df}_{1}}{dx} \frac{{df}_{m}}{dx} & \frac{{df}_{2}}{dx} \frac{{df}_{m}}{dx} & … & \frac{{df}_{m}}{dx} \frac{{df}_{m}}{dx}\end{matrix} ]}_{x = 0} , {Ks}_{4} = {{K}_{2} [ \begin{matrix}\frac{{df}_{1}}{dx} \frac{{df}_{1}}{dx} & \frac{{df}_{1}}{dx} \frac{{df}_{2}}{dx} & … & \frac{{df}_{1}}{dx} \frac{{df}_{m}}{dx} \\ \frac{{df}_{1}}{dx} \frac{{df}_{2}}{dx} & \frac{{df}_{2}}{dx} \frac{{df}_{2}}{dx} & … & \frac{{df}_{2}}{dx} \frac{{df}_{m}}{dx} \\ ⋮ & ⋮ & ⋮ & ⋮ \\ \frac{{df}_{1}}{dx} \frac{{df}_{m}}{dx} & \frac{{df}_{2}}{dx} \frac{{df}_{m}}{dx} & … & \frac{{df}_{m}}{dx} \frac{{df}_{m}}{dx}\end{matrix} ]}_{x = L} \\ {M}_{1} = {ρ}_{1} {A}_{1} [ \begin{matrix}{\int }_{0}^{{L}_{1}} {f}_{1} {f}_{1} dx & {\int }_{0}^{{L}_{1}} {f}_{1} {f}_{2} dx & … & {\int }_{0}^{{L}_{1}} {f}_{1} {f}_{m} dx \\ {\int }_{0}^{{L}_{1}} {f}_{2} {f}_{1} dx & {\int }_{0}^{{L}_{1}} {f}_{2} {f}_{2} dx & … & {\int }_{0}^{{L}_{1}} {f}_{2} {f}_{m} dx \\ ⋮ & ⋮ & ⋮ & ⋮ \\ {\int }_{0}^{{L}_{1}} {f}_{m} {f}_{1} dx & {\int }_{0}^{{L}_{1}} {f}_{m} {f}_{2} dx & … & {\int }_{0}^{{L}_{1}} {f}_{m} {f}_{m} dx\end{matrix} ] , \\ … \\ {M}_{p} = {ρ}_{p} {A}_{p} [ \begin{matrix}{\int }_{{L}_{1} + {L}_{2} … {L}_{i - 1}}^{{L}_{1} + {L}_{2} … {L}_{i}} {f}_{1} {f}_{1} d x & {\int }_{{L}_{1} + {L}_{2} … {L}_{i - 1}}^{{L}_{1} + {L}_{2} … {L}_{i}} {f}_{1} {f}_{2} d x & … & {\int }_{{L}_{1} + {L}_{2} … {L}_{i - 1}}^{{L}_{1} + {L}_{2} … {L}_{i}} {f}_{1} {f}_{m} d x \\ {\int }_{{L}_{1} + {L}_{2} … {L}_{i - 1}}^{{L}_{1} + {L}_{2} … {L}_{i}} {f}_{2} {f}_{1} dx & {\int }_{{L}_{1} + {L}_{2} … {L}_{i - 1}}^{{L}_{1} + {L}_{2} … {L}_{i}} {f}_{2} {f}_{2} d x & … & {\int }_{{L}_{1} + {L}_{2} … {L}_{i - 1}}^{{L}_{1} + {L}_{2} … {L}_{i}} {f}_{2} {f}_{m} d x \\ ⋮ & ⋮ & ⋮ & ⋮ \\ {\int }_{{L}_{1} + {L}_{2} … {L}_{i - 1}}^{{L}_{1} + {L}_{2} … {L}_{i}} {f}_{m} {f}_{1} d x & {\int }_{{L}_{1} + {L}_{2} … {L}_{i - 1}}^{{L}_{1} + {L}_{2} … {L}_{i}} {f}_{m} {f}_{2} d x & … & {\int }_{{L}_{1} + {L}_{2} … {L}_{i - 1}}^{{L}_{1} + {L}_{2} … {L}_{i}} {f}_{m} {f}_{m} d x\end{matrix} ] .$$

A condition for the system of the homogeneous linear equation to have a nontrivial solution is: a value of the coefficient determinant of the system of the homogeneous linear equation is zero, to obtain a frequency equation.

In the embodiment, through the above-mentioned calculation steps, a stiffness matrix and a mass matrix of the multi-segment stepped beam with the following common boundary conditions can be derived, and the natural frequency values of the beam in different orders can be obtained by solving for the eigenvalue problem. The boundary conditions include:

(1) one end of the beam is simply supported and hinged, and the other end of the beam is clamped;

(2) one end of the beam is a simply supported and hinged, and the other end of the beam is free;

(3) one end of the beam is clamped, and the other end is free;

(4) both ends of the beam are clamped;

(5) one end of the beam is simply supported and hinged, and the other end of the beam is constrained by a wire spring and a torsion spring;

(6) one end of the beam is clamped, and the other end of the beam is constrained by a wire spring and a torsion spring; and

(7) both ends of the beam are constrained by a wire spring and a torsion spring.

For a multi-segment continuous beam with any one of the above-mentioned boundary conditions, after obtaining the expressions of its mass matrix and stiffness matrix, its cross-sectional shape, cross-sectional dimensions, total length and lengths of segments of the beam, and material parameters of the segments of the beam can be changed arbitrarily, and the circular frequency values of each order of the multi-segment continuous beam under corresponding changes can be quickly obtained by using Mathematica, thereby solving the problem that there is no calculation formula or method to calculate the natural circular frequencies of different orders of the current multi-segment continuous beams with different lengths, sizes and materials under given elastic boundary conditions.

### Embodiment 1

Taking the cantilever multi-segmental continuous beam shown in the figure as an example, after a mass matrix and a stiffness matrix of its bending vibration are given, the natural circular frequency can be calculated through the matrix eigenvalue problem. This method is suitable for cantilever multi-segment beams with different segment lengths, different cross-sectional shapes and different cross-sectional dimensions.

As shown in the figure, a total length of the beam is L and the beam is divided into 2 segments, where a length of a left segment is L₁; a mass per unit volume of the left segment is ρ₁; an area of a cross section of the left segment is A₁; a moment of inertia of the cross section of the left segment is I₁; and an elastic modulus of the left segment is E₁. A length of a right segment is L₂; a mass per unit volume of the right segment is ρ₂; an area of a cross section of the right segment is A₂; a moment of inertia of a cross section of the right segment is I₂; and an elastic modulus of the right segment is E₂.

It is assumed that w(x, t) is the lateral displacement of the cross section of the multi-segment continuous beam from the coordinate origin x at the t moment.

Based on the variable separation method, the modal solution is set as follows:

w(x,t)=W(x)e^{iwt} (4).

The function is set as follows:

$${Kp}_{1} = {E}_{1} {I}_{1} [ \begin{matrix}{\int }_{0}^{{L}_{1}} \frac{{d}^{2} {f}_{1}}{{dx}^{2}} \frac{{d}^{2} {f}_{1}}{{dx}^{2}} dx & {\int }_{0}^{{L}_{1}} \frac{{d}^{2} {f}_{1}}{{dx}^{2}} \frac{{d}^{2} {f}_{2}}{{dx}^{2}} dx & … & {\int }_{0}^{{L}_{1}} \frac{{d}^{2} {f}_{1}}{{dx}^{2}} \frac{{d}^{2} {f}_{m}}{{dx}^{2}} dx \\ {\int }_{0}^{{L}_{1}} \frac{{d}^{2} {f}_{2}}{{dx}^{2}} \frac{{d}^{2} {f}_{1}}{{dx}^{2}} dx & {\int }_{0}^{{L}_{1}} \frac{{d}^{2} {f}_{2}}{{dx}^{2}} \frac{{d}^{2} {f}_{2}}{{dx}^{2}} dx & … & {\int }_{0}^{{L}_{1}} \frac{{d}^{2} {f}_{2}}{{dx}^{2}} \frac{{d}^{2} {f}_{m}}{{dx}^{2}} dx \\ ⋮ & ⋮ & ⋮ & ⋮ \\ {\int }_{0}^{{L}_{1}} \frac{{d}^{2} {f}_{m}}{{dx}^{2}} \frac{{d}^{2} {f}_{1}}{{dx}^{2}} dx & {\int }_{0}^{{L}_{1}} \frac{{d}^{2} {f}_{m}}{{dx}^{2}} \frac{{d}^{2} {f}_{2}}{{dx}^{2}} dx & … & {\int }_{0}^{{L}_{1}} \frac{{d}^{2} {f}_{m}}{{dx}^{2}} \frac{{d}^{2} {f}_{m}}{{dx}^{2}} dx\end{matrix} ] , \\ …$$

$$K {p}_{p} = {E}_{p} {I}_{p} [ \begin{matrix}{\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{m}}{{dx}^{2}} dx \\ {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{m}}{{dx}^{2}} dx \\ ⋮ & ⋮ & ⋮ & ⋮ \\ {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{m}}{{dx}^{2}} dx\end{matrix} ]$$

$${Ks}_{1} = {{k}_{1} [ \begin{matrix}{f}_{1} {f}_{1} & {f}_{1} {f}_{2} & … & {f}_{1} {f}_{m} \\ {f}_{1} {f}_{2} & {f}_{2} {f}_{2} & … & {f}_{2} {f}_{m} \\ ⋮ & ⋮ & ⋮ & ⋮ \\ {f}_{1} {f}_{m} & {f}_{2} {f}_{m} & … & {f}_{m} {f}_{n}\end{matrix} ]}_{x = 0} , {Ks}_{2} = {{k}_{2} [ \begin{matrix}{f}_{1} {f}_{1} & {f}_{1} {f}_{2} & … & {f}_{1} {f}_{m} \\ {f}_{1} {f}_{2} & {f}_{2} {f}_{2} & … & {f}_{2} {f}_{m} \\ ⋮ & ⋮ & ⋮ & ⋮ \\ {f}_{1} {f}_{m} & {f}_{2} {f}_{m} & … & {f}_{m} {f}_{n}\end{matrix} ]}_{x = L} , \\ {Ks}_{3} = {{K}_{1} [ \begin{matrix}\frac{{df}_{1}}{dx} \frac{{df}_{1}}{dx} & \frac{{df}_{1}}{dx} \frac{{df}_{2}}{dx} & … & \frac{{df}_{1}}{dx} \frac{{df}_{m}}{dx} \\ \frac{{df}_{1}}{dx} \frac{{df}_{2}}{dx} & \frac{{df}_{2}}{dx} \frac{{df}_{2}}{dx} & … & \frac{{df}_{2}}{dx} \frac{{df}_{m}}{dx} \\ ⋮ & ⋮ & ⋮ & ⋮ \\ \frac{{df}_{1}}{dx} \frac{{df}_{m}}{dx} & \frac{{df}_{2}}{dx} \frac{{df}_{m}}{dx} & … & \frac{{df}_{m}}{dx} \frac{{df}_{m}}{dx}\end{matrix} ]}_{x = 0} , {Ks}_{4} = {{K}_{2} [ \begin{matrix}\frac{{df}_{1}}{dx} \frac{{df}_{1}}{dx} & \frac{{df}_{1}}{dx} \frac{{df}_{2}}{dx} & … & \frac{{df}_{1}}{dx} \frac{{df}_{m}}{dx} \\ \frac{{df}_{1}}{dx} \frac{{df}_{2}}{dx} & \frac{{df}_{2}}{dx} \frac{{df}_{2}}{dx} & … & \frac{{df}_{2}}{dx} \frac{{df}_{m}}{dx} \\ ⋮ & ⋮ & ⋮ & ⋮ \\ \frac{{df}_{1}}{dx} \frac{{df}_{m}}{dx} & \frac{{df}_{2}}{dx} \frac{{df}_{m}}{dx} & … & \frac{{df}_{m}}{dx} \frac{{df}_{m}}{dx}\end{matrix} ]}_{x = L}$$

$${M}_{1} = {ρ}_{1} {A}_{1} [ \begin{matrix}{\int }_{0}^{{L}_{1}} {f}_{1} {f}_{1} dx & {\int }_{0}^{{L}_{1}} {f}_{1} {f}_{2} dx & … & {\int }_{0}^{{L}_{1}} {f}_{1} {f}_{m} dx \\ {\int }_{0}^{{L}_{1}} {f}_{2} {f}_{1} dx & {\int }_{0}^{{L}_{1}} {f}_{2} {f}_{2} dx & … & {\int }_{0}^{{L}_{1}} {f}_{2} {f}_{m} dx \\ ⋮ & ⋮ & ⋮ & ⋮ \\ {\int }_{0}^{{L}_{1}} {f}_{m} {f}_{1} dx & {\int }_{0}^{{L}_{1}} {f}_{m} {f}_{2} dx & … & {\int }_{0}^{{L}_{1}} {f}_{m} {f}_{m} dx\end{matrix} ] , \\ …$$

$${M}_{p} = {ρ}_{p} {A}_{p} [ \begin{matrix}{\int }_{{L}_{1} + {L}_{2} … {L}_{i - 1}}^{{L}_{1} + {L}_{2} … {L}_{i}} {f}_{1} {f}_{1} d x & {\int }_{{L}_{1} + {L}_{2} … {L}_{i - 1}}^{{L}_{1} + {L}_{2} … {L}_{i}} {f}_{1} {f}_{2} d x & … & {\int }_{{L}_{1} + {L}_{2} … {L}_{i - 1}}^{{L}_{1} + {L}_{2} … {L}_{i}} {f}_{1} {f}_{m} d x \\ {\int }_{{L}_{1} + {L}_{2} … {L}_{i - 1}}^{{L}_{1} + {L}_{2} … {L}_{i}} {f}_{2} {f}_{1} dx & {\int }_{{L}_{1} + {L}_{2} … {L}_{i - 1}}^{{L}_{1} + {L}_{2} … {L}_{i}} {f}_{2} {f}_{2} d x & … & {\int }_{{L}_{1} + {L}_{2} … {L}_{i - 1}}^{{L}_{1} + {L}_{2} … {L}_{i}} {f}_{2} {f}_{m} d x \\ ⋮ & ⋮ & ⋮ & ⋮ \\ {\int }_{{L}_{1} + {L}_{2} … {L}_{i - 1}}^{{L}_{1} + {L}_{2} … {L}_{i}} {f}_{m} {f}_{1} d x & {\int }_{{L}_{1} + {L}_{2} … {L}_{i - 1}}^{{L}_{1} + {L}_{2} … {L}_{i}} {f}_{m} {f}_{2} d x & … & {\int }_{{L}_{1} + {L}_{2} … {L}_{i - 1}}^{{L}_{1} + {L}_{2} … {L}_{i}} {f}_{m} {f}_{m} d x\end{matrix} ]$$

a matrix of the linear equation system is as follows:

[(M₁+M₂)ω²−(Kp₁+Kp₂+Ks₁+Ks₂+Ks₃+Ks₄)]A=0 (8);

where A={a₋₄, a₋₃, . . . , a₈, a₉}^{T}; based on the necessary and sufficient condition for the linear equations to have nontrivial solutions, the determinant of the coefficients of the equations should be zero to obtain the frequency equation:

|(M₁+M₂)ω²−(Kp₁+Kp₂+Ks₁+Ks₂+Ks₃+Ks₄)|=0 (9);

where ω is the circular frequency to be determined. The matrices M₁, M₂, Kp₁, Kp₂, Ks₁, Ks₂, Ks₃, and Ks₄ need to be established using Mathematica. The equation (9) corresponds to the eigenvalue problem of the matrix, where the eigenvalue problem of the matrix is very complicated, which cannot be solved for manually and can only be solved for by using Mathematica.

(1) The cross sections of the left segment and the right segment are circular: it is assumed that in the figure, a diameter of the left segment is d₁; an area of the circular cross section of the left segment is A₁=πd²/4; the axial moment of inertia of the left segment is I₁=πd₁⁴/64; a diameter of the right segment is d₂; an area of the circular cross section of the right segment is A₂=πd²/4; and the axial moment of inertia of the right segment is I₂=π·d₂⁴/64.

A) When a ratio of L₁ to L₂ takes different values

A diameter of the circular cross section of the left segment is d₁=40 mm; a diameter of the circular cross section of the right segment is d₂=30 mm; a total length of the beam is L=0.15 m, E₁=E₂=210 GPa, ρ₁=ρ₂=7800 kg/m³. Under the cantilever boundary condition, when the ratio of the length L₁ of the left segment and the length L₂ of the right segment of the beam takes different values, the first-order frequency obtained by this method is compared with the result of the traditional analytical method. As shown in Table 1, under the cantilever boundary condition, the first-order natural frequency of the multi-segment beam continuously increases as the ratio of the length L₁ of the left segment to the length L₂ of the right segment decreases, and decreases when it approaches 1.

TABLE 1
Natural frequencies (rad/s) of a double-segment beam corresponding
to the values of L₁/L₂ under C-F boundary

| | L₁/L₂ | | | | | |
|---|---|---|---|---|---|---|
| ω | 8 | 3.5 | 2 | 1.75 | 1.25 | 1 |
| Analytical | 8876.48 | 9556.34 | 10044.8 | 10125.6 | 10191.1 | 10090.8 |
| method | | | | | | |
| This | 8876.95 | 9537.11 | 10058.2 | 10167 | 10220.2 | 10152.4 |
| method | | | | | | |
| Error (%) | 0 | −0.20 | 0.13 | 0.41 | 0.29 | 0.61 |

B) When a ratio of d₁ to d₁ takes different values

A double-segment beam with a circular section under the cantilever boundary condition is selected, where a length of the left segment is L₁=0.117 m; a length of the right segment is L₂=0.033 m; E₁=E₂=210 GPa; and ρ₁=ρ₂=7800 kg/m³. Under the cantilever boundary condition, a diameter of the circular section of the left segment of the beam is d₁=0.04 m. After changing the ratio of the diameter d₁ of the circular section of the left segment to the diameter d₂ of the circular section of the right segment of the beam, it can be found that the first-order frequency obtained by this method is consistent with the result of the traditional analytical method through comparison. As shown in Table 2, under the cantilever boundary condition, the first-order natural frequency of the multi-segment beam continuously decreases as the ratio of the diameter d₁ of the circular section of the left segment to the diameter d₂ of the circular section of the right segment decreases.

TABLE 2
Natural frequencies of a double-segment beam corresponding to values
of d₁/d₂ under C-F boundary

| | d₁/d₂ | | | | | | | |
|---|---|---|---|---|---|---|---|---|
| ω | 7 | 6 | 5 | 4 | 3 | 2 | 1 | 0.5 |
| Analytical | 13048.9 | 12981.1 | 12864.7 | 12653.0 | 12222.5 | 11184.0 | 8108.31 | 4738.1 |
| method | | | | | | | | |
| This | 13212.1 | 13090.2 | 12931.0 | 12652.1 | 12222.3 | 11182.0 | 8109.94 | 4769.04 |
| method | | | | | | | | |
| Error (%) | 1.3 | 0.84 | 0.52 | 0 | 0 | −0.02 | 0.02 | 0.65 |

C) When the left segment and the right segment are of different materials or different bending stiffness ratios

A double-segment beam with a circular section under the cantilever boundary condition is selected. The length of the left segment is L₁=0.117 m; the length of the right segment is L₂=0.033 m; ρ₁=ρ₂=7800 kg/m³; a diameter of the circular section of the left segment is d1 =0.04 m, and a diameter of the circular section of the right segment is d₂=0.038 m. Under the cantilever boundary condition, when the ratio of E₁I₁ to E₂I₂ changes, the first-order frequency obtained by this method is compared with the result of the traditional analytical method, and the error is within the allowable range.

TABLE 3
Natural frequency (rad/s) of a double-segment
beam corresponding to values of E₁I₁/E₂I₂
under C-F boundary

| | | | Analytical | This | |
|---|---|---|---|---|---|
| E₁ | E₂ | E₁I₁/ | method | method | Error |
| (GPa) | (GPa) | E₂I₂ | ω (rad/s) | ω (rad/s) | (%) |
| 127 | 70 | 2.227 | 6508.14 | 6507.12 | −0.02 |
| 206 | 120 | 2.108 | 8289.24 | 8289.86 | 0 |
| 108 | 68 | 1.949 | 6002.42 | 5991.20 | −0.19 |
| 145 | 103 | 1.729 | 6955.79 | 6947.16 | −0.12 |
| 206 | 173 | 1.462 | 8291.84 | 8307.24 | 0.19 |

(2) The cross sections of the left segment and the right segment are rectangular: it is assumed that a width of the cross section of the left segment L₁ in the figure is b₁; a height of the cross section of the left segment L₁ is h₁; the area of the cross section of the cross section of the left segment L₁ is A₁=b₁h₁; and the axial moment of inertia of the cross section of the left segment L₁ is I₁=b₁h₁³/12; a width of the cross section of the right segment L₂ is b₂; the height of the cross section of the right segment L₂ is h₂; the area of the cross section of the right segment L₂ is A₂=b₂h₂; and the axial moment of inertia of the cross section of the right segment L₂ is I₂=b₂h₂³/12.

A) When a ratio of L₁ to L₂ takes different values

The width b₁ of the left segment of rectangular segment is 40 mm, and a height h₁ of the left segment of rectangular segment is 30 mm; the width b₂ of the cross section of the right segment is 20 mm, and the height h₂ of the cross section of the right segment is 15 mm; the total length L of the double-segment beam is 0.15 m; E₁=E₂=210 GPa; ρ₁=ρ₂=7800 kg/m³. Under the cantilever boundary condition, when the ratio of the length L₁ of the left segment to the length L₂ of the right segment takes different values, it can be seen that the data of the first-order frequency obtained by this method is consistent with the result of the traditional analytical method through comparison. As shown in Table 4, under the cantilever boundary condition, the first-order natural frequency of the multi-segment beam with rectangular cross section increases with the decrease of the ratio of the length L₁ of the left segment to the length L₂ of the right segment, and decreases when it approaches 1.

TABLE 4
Natural frequencies of a double-segment beam with rectangular
sections corresponding to values of L₁/L₂ under the C-F boundary

| | L₁/L₂ | | | | | |
|---|---|---|---|---|---|---|
| ω | 8 | 3.5 | 2 | 1.75 | 1.25 | 1 |
| Analytical | 8291.86 | 9714.37 | 10959.3 | 11137.3 | 10898.2 | 10125.5 |
| method | | | | | | |
| This | 8323.36 | 9721.02 | 11062.0 | 11386.7 | 11481.0 | 10801.7 |
| method | | | | | | |
| Error (%) | 0.38 | 0.07 | 0.94 | 2.23 | 5.3 | 6.7 |

B) When a ratio of A₁ to A₂ takes different values

A double-segment beam with a rectangular cross-section under the cantilever boundary condition is selected, where the length of the left segment is L₁=0.117 m; a length of the right segment is L₂=0.033 m; E₁=E₂=210 GPa; and ρ₁=ρ₂=7800 kg/m³. Under the cantilever boundary condition, the influence of the ratio of the area A₁ of the rectangular cross section of the left segment to the area A₂ of the rectangular cross section of the right segment on the first-order natural frequency of the beam with the rectangular cross section is studied. It can be seen that the data of the first-order frequency is consistent with the result of the traditional analytical method through comparison. As shown in Table 5, the first-order natural frequency of the multi-segment beam with the rectangular cross section continuously decreases as the ratio of the area A₁ of the cross section of the left segment to the area A₂ of the cross section of the right segment decreases under the cantilever boundary condition.

TABLE 5
Natural frequencies (rad/s) of a double-segment
rectangular beam corresponding to values of A₁/A₂
under C-F boundary

| | | | Analytical | This | |
|---|---|---|---|---|---|
| A₁ | A₂ | A₁/ | method | method | Error |
| (mm²) | (mm²) | A₂ | ω (rad/s) | ω (rad/s) | (%) |
| 37 × 27 | 34 × 24 | 1.224 | 6724.62 | 6720.34 | −0.06 |
| 45 × 35 | 42 × 32 | 1.172 | 8604.63 | 8598.65 | −0.07 |
| 35 × 25 | 33 × 23 | 1.153 | 6115.92 | 6148.12 | 0.53 |
| 39 × 29 | 37 × 27 | 1.132 | 7055.65 | 7052.39 | −0.05 |
| 40 × 30 | 38 × 28 | 1.128 | 7290.47 | 7297.26 | 0.09 |

C) When the left segment and the right segment are of different materials or different bending stiffness ratios

A double-segment beam with a rectangular section under the cantilever boundary condition is selected. The length of the left segment is L₁=0.117 m, and the length of the right segment is L₂=0.033 m. ρ₁=ρ₂=7800 kg/m³, b₁×h₁=40 mm×30 mm, and b₂×h₂=20 mm×15 mm. As shown in Table 6, under the cantilever boundary condition, when the ratio of E₁I₁ to E₂I₂ changes, the first-order frequency obtained by this method is compared with the result of the traditional analytical method, and it can be seen that the error is within the allowable range.

TABLE 6
Natural frequencies (rad/s) of a double-segment
rectangular beam corresponding to values of E₁I₁/
E₂I₂ under C-F boundary

| | | | Analytical | This | |
|---|---|---|---|---|---|
| E₁ | E₂ | E₁I₁/ | method | method | Error |
| (GPa) | (GPa) | E₂I₂ | ω (rad/s) | ω (rad/s) | (%) |
| 127 | 70 | 29.03 | 7520.18 | 7551.17 | 0.41 |
| 206 | 120 | 27.47 | 9579.52 | 9609.41 | 0.31 |
| 108 | 68 | 25.41 | 6937.95 | 6941.16 | 0.05 |
| 145 | 103 | 22.52 | 8041.87 | 8075.41 | 0.42 |
| 206 | 173 | 19.05 | 9589.36 | 9605.10 | 0.16 |

The method of this embodiment is not limited to beams with specific boundaries and is applicable to beams with arbitrary elastic boundaries. At the same, it is applicable to both a single-segment beam and a beam with multiple segments, which can provide excellent reference for the analysis of the vibration characteristics of multi-segment continuous beams in engineering applications. Thus, the method of the present disclosure has broad market prospects.

It should be understood that, the above-mentioned embodiments are illustrative of the present disclosure, but not intended to limit the present disclosure. Any modification and improvement made without departing from the spirit of the present disclosure shall fall within the scope of the invention which is defined by the appended claims and equivalents thereof.

What is claimed is:

1. A method for calculation of a natural frequency of a multi-segment continuous beam, comprising:
(1) arranging a displacement spring and a rotational spring on each of two ends of the multi-segment continuous beam to simulate arbitrary boundary conditions;
(2) constructing a lateral displacement function of the multi-segment continuous beam along a full length thereof, and expressing the lateral displacement function in a form of an improved Fourier series, wherein the improved Fourier series is formed by adding four auxiliary functions into the classic Fourier series;
(3) calculating a strain energy of the multi-segment continuous beam;
(4) calculating an elastic potential energy of the displacement spring and the rotational spring at a boundary of the multi-segment continuous beam;
(5) calculating a maximum value of a kinetic energy of the multi-segment continuous beam;
(6) calculating a Lagrangian function of the multi-segment continuous beam;
(7) substituting the improved Fourier series of the lateral displacement function into the Lagrange function;
(8) taking an extreme value of each of undetermined coefficients in the improved Fourier series in the Lagrangian function to let a partial derivative be zero, so as to obtain a system of homogeneous linear equations;
(9) converting the system of homogeneous linear equations into a matrix form; and
(10) solving for an eigenvalue problem of the matrix to obtain the natural frequency.

2. The method of claim 1, wherein in step (1), a stiffness value of the displacement spring and a stiffness value of the rotational spring at a first boundary are respectively denoted as k₁ and K₁, and a stiffness value of the displacement spring and a stiffness value of the rotational spring at a second boundary are respectively denoted as k₂ and K₂; when the boundary is a clamped boundary, the stiffness value of the displacement spring and the stiffness value of the rotational spring need to be set to infinity at the same time, and the stiffness value of the displacement spring and the stiffness value of the rotational spring are set to 10¹³, respectively; when the boundary is a free boundary, the stiffness value of the displacement spring and the stiffness value of the rotational spring are set to zero; when the boundary is a simply supported boundary, the stiffness value of the displacement spring is set to 10¹³, and the stiffness value of the rotational spring is 0; and when the stiffness value of the displacement spring and the stiffness value of the rotational spring are finite values, an elastic constraint boundary condition is simulated.

3. The method of claim 1, wherein the lateral displacement function of the multi-segment continuous beam over the full length thereof expressed in the form of the improved Fourier series in step (2) is:
$$W ( x ) = {\sum }_{n = 0}^{9} {a}_{n} cos ( {λ}_{n} x ) + {\sum }_{n = - 4}^{- 1} {a}_{n} sin ( {λ}_{n} x ) ; \qquad ( 1 )$$
wherein x ∈[0,L]; aₙ is an undetermined constant; and λₙ=nπ/L

4. The method of claim 1, wherein the strain energy of the multi-segment continuous beam in step (3) is:
$${V}_{P} = \frac{1}{2} {E}_{1} {I}_{1} {\int }_{0}^{{L}_{1}} {( \frac{{d}^{2} w}{{dx}^{2}} )}^{2} dx + \frac{1}{2} {\sum }_{i = 2}^{i = p} {E}_{i} {I}_{i} {\int }_{{L}_{1} + {L}_{2} … {L}_{i - 1}}^{{L}_{1} + {L}_{2} … {L}_{i}} {( \frac{{d}^{2} w}{d {x}^{2}} )}^{2} dx ; \qquad ( 2 )$$
wherein a total length of the multi-segment continuous beam is L; the multi-segment continuous beam is divided into p segments; a length of an i-th segment is Lᵢ; Vp is the strain energy of the multi-segment continuous beam under arbitrary boundary conditions; Eᵢ is an elastic modulus of the i-th segment, and Iᵢ is a moment of inertia of a cross section of the i-th segment.

5. The method of claim 1, wherein the elastic potential energy Vs of the displacement spring and the rotational spring at the boundary of the multi-segment continuous beam in step (4) is:
$${V}_{s} = \frac{1}{2} ( {k}_{1} {w}^{2} {\vert}_{x = 0} + {{K}_{1} ( \frac{\partial w}{\partial x} )}^{2} {\vert}_{x = 0} + {k}_{2} {w}^{2} {\vert}_{x = L} + {{K}_{2} ( \frac{\partial w}{\partial x} )}^{2} {\vert}_{x = L} ) . \qquad ( 3 )$$

6. The method of claim 1, wherein a form of a modal solution of the multi-segment continuous beam is assumed based on a variable separation method in step (2) as:
w(x,t)=W(x)e^{iwt} (4);
wherein i is an imaginary unit, and ω is the natural frequency of the multi-segment continuous beam.

7. The method of claim 1, wherein the maximum value of the kinetic energy of the multi-segment continuous beam in step (5) is:
$${T}_{ma x} = \frac{1}{2} ρ ( x ) {\int }_{0}^{L} S ( x ) {( \frac{d w}{d t} )}^{2} d x = \frac{{ω}^{2}}{2} {\int }_{0}^{L} ρ ( x ) S ( x ) {w}^{2} dx . \qquad ( 5 )$$

8. The method of claim 1, wherein the Lagrangian function of the multi-segment continuous beam in step (6) is:
$$L = {V}_{ma x} - {T}_{m ax} = {V}_{p} + {V}_{s} - {T}_{ ma x} . \qquad ( 6 )$$

9. The method of claim 1, wherein in step (8), the partial derivative of the undertermined coefficient an (n=−4, −3, . . . , 9) is calculated item by item in the Lagrangian function, to obtain the system of homogeneous linear equations:
[(M₁+ . . . +Mₚ)ω²(Kp₁+ . . . +Kpₚ+Ks₁+Ks₂+Ks₃+Ks₄)]A=0 (7);
wherein A={a₋₄, a₋₃, . . . , a₈, a₉}^{T},
$${Kp}_{1} = {E}_{1} {I}_{1} [ \begin{matrix}{\int }_{0}^{{L}_{1}} \frac{{d}^{2} {f}_{1}}{{dx}^{2}} \frac{{d}^{2} {f}_{1}}{{dx}^{2}} dx & {\int }_{0}^{{L}_{1}} \frac{{d}^{2} {f}_{1}}{{dx}^{2}} \frac{{d}^{2} {f}_{2}}{{dx}^{2}} dx & … & {\int }_{0}^{{L}_{1}} \frac{{d}^{2} {f}_{1}}{{dx}^{2}} \frac{{d}^{2} {f}_{m}}{{dx}^{2}} dx \\ {\int }_{0}^{{L}_{1}} \frac{{d}^{2} {f}_{2}}{{dx}^{2}} \frac{{d}^{2} {f}_{1}}{{dx}^{2}} dx & {\int }_{0}^{{L}_{1}} \frac{{d}^{2} {f}_{2}}{{dx}^{2}} \frac{{d}^{2} {f}_{2}}{{dx}^{2}} dx & … & {\int }_{0}^{{L}_{1}} \frac{{d}^{2} {f}_{2}}{{dx}^{2}} \frac{{d}^{2} {f}_{m}}{{dx}^{2}} dx \\ ⋮ & ⋮ & ⋮ & ⋮ \\ {\int }_{0}^{{L}_{1}} \frac{{d}^{2} {f}_{m}}{{dx}^{2}} \frac{{d}^{2} {f}_{1}}{{dx}^{2}} dx & {\int }_{0}^{{L}_{1}} \frac{{d}^{2} {f}_{m}}{{dx}^{2}} \frac{{d}^{2} {f}_{2}}{{dx}^{2}} dx & … & {\int }_{0}^{{L}_{1}} \frac{{d}^{2} {f}_{m}}{{dx}^{2}} \frac{{d}^{2} {f}_{m}}{{dx}^{2}} dx\end{matrix} ] , \\ …$$
$${Kp}_{p} = {E}_{p} {I}_{p} [ \begin{matrix}{\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{1}}{{dx}^{2}} \frac{{d}^{2} {f}_{m}}{{dx}^{2}} dx \\ {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{2}}{{dx}^{2}} \frac{{d}^{2} {f}_{m}}{{dx}^{2}} dx \\ … & … & ⋮ & … \\ {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{1}}{{dx}^{2}} dx & {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{2}}{{dx}^{2}} dx & … & {\int }_{{L}_{1} + {L}_{2} … {L}_{i - 1}}^{{L}_{1} + {L}_{2} … {L}_{i}} \frac{{d}^{2} {f}_{m}}{{dx}^{2}} \frac{{d}^{2} {f}_{m}}{{dx}^{2}} dx\end{matrix} ]$$
$${Ks}_{1} = {k}_{1} [ \begin{matrix}{f}_{1} {f}_{1} & {f}_{1} {f}_{2} & ⋯ & {f}_{1} {f}_{m} \\ {f}_{1} {f}_{2} & {f}_{2} {f}_{2} & ⋯ & {f}_{2} {f}_{m} \\ ⋮ & ⋮ & ⋮ & ⋮ \\ {f}_{1} {f}_{m} & {f}_{2} {f}_{m} & ⋯ & {f}_{m} {f}_{m}\end{matrix} ] {\vert}_{x = 0} , \\ {Ks}_{2} = {k}_{2} [ \begin{matrix}{f}_{1} {f}_{1} & {f}_{1} {f}_{2} & ⋯ & {f}_{1} {f}_{m} \\ {f}_{1} {f}_{2} & {f}_{2} {f}_{2} & ⋯ & {f}_{2} {f}_{m} \\ ⋮ & ⋮ & ⋮ & ⋮ \\ {f}_{1} {f}_{m} & {f}_{2} {f}_{m} & ⋯ & {f}_{m} {f}_{m}\end{matrix} ] {\vert}_{x = L} , \\ {Ks}_{3} = {K}_{1} [ \begin{matrix}\frac{{df}_{1}}{dx} \frac{{df}_{1}}{dx} & \frac{{df}_{1}}{dx} \frac{{df}_{2}}{dx} & ⋯ & \frac{{df}_{1}}{dx} \frac{{df}_{m}}{dx} \\ \frac{{df}_{1}}{dx} \frac{{df}_{2}}{dx} & \frac{{df}_{2}}{dx} \frac{{df}_{2}}{dx} & ⋯ & \frac{{df}_{2}}{dx} \frac{{df}_{m}}{dx} \\ ⋮ & ⋮ & ⋮ & ⋮ \\ \frac{{df}_{1}}{dx} \frac{{df}_{m}}{dx} & \frac{{df}_{2}}{dx} \frac{{df}_{m}}{dx} & ⋯ & \frac{{df}_{m}}{dx} \frac{{df}_{m}}{dx}\end{matrix} ] {\vert}_{x = 0} , \\ {Ks}_{4} = {K}_{2} = [ \begin{matrix}\frac{{df}_{1}}{dx} \frac{{df}_{1}}{dx} & \frac{{df}_{1}}{dx} \frac{{df}_{2}}{dx} & ⋯ & \frac{{df}_{1}}{dx} \frac{{df}_{m}}{dx} \\ \frac{{df}_{1}}{dx} \frac{{df}_{2}}{dx} & \frac{{df}_{2}}{dx} \frac{{df}_{2}}{dx} & ⋯ & \frac{{df}_{2}}{dx} \frac{{df}_{m}}{dx} \\ ⋮ & ⋮ & ⋮ & ⋮ \\ \frac{{df}_{1}}{dx} \frac{{df}_{m}}{dx} & \frac{{df}_{2}}{dx} \frac{{df}_{m}}{dx} & ⋯ & \frac{{df}_{m}}{dx} \frac{{df}_{m}}{dx}\end{matrix} ] {\vert}_{x = L} \\ {M}_{1} = {ρ}_{1} {A}_{1} [ \begin{matrix}{\int }_{0}^{{L}_{1}} {f}_{1} {f}_{1} dx & {\int }_{0}^{{L}_{1}} {f}_{1} {f}_{2} dx & ⋯ & {\int }_{0}^{{L}_{1}} {f}_{1} {f}_{m} dx \\ {\int }_{0}^{{L}_{1}} {f}_{2} {f}_{1} dx & {\int }_{0}^{{L}_{1}} {f}_{2} {f}_{2} dx & ⋯ & {\int }_{0}^{{L}_{1}} {f}_{2} {f}_{m} dx \\ ⋮ & ⋮ & ⋮ & ⋮ \\ {\int }_{0}^{{L}_{1}} {f}_{m} {f}_{1} dx & {\int }_{0}^{{L}_{1}} {f}_{m} {f}_{2} dx & ⋯ & {\int }_{0}^{{L}_{1}} {f}_{m} {f}_{m} dx\end{matrix} ] , \\ …$$
$${M}_{p} = {ρ}_{p} {A}_{p} = [ \begin{matrix}{\int }_{{L}_{1} + {L}_{2} ⋯ {L}_{i - 1}}^{{L}_{1} + {L}_{2} ⋯ {L}_{i}} {f}_{1} {f}_{1} dx & {\int }_{{L}_{1} + {L}_{2} ⋯ {L}_{i - 1}}^{{L}_{1} + {L}_{2} ⋯ {L}_{i}} {f}_{1} {f}_{2} dx & ⋯ & {\int }_{{L}_{1} + {L}_{2} ⋯ {L}_{i - 1}}^{{L}_{1} + {L}_{2} ⋯ {L}_{i}} {f}_{1} {f}_{m} dx \\ {\int }_{{L}_{1} + {L}_{2} ⋯ {L}_{i - 1}}^{{L}_{1} + {L}_{2} ⋯ {L}_{i}} {f}_{2} {f}_{1} dx & {\int }_{{L}_{1} + {L}_{2} ⋯ {L}_{i - 1}}^{{L}_{1} + {L}_{2} ⋯ {L}_{i}} {f}_{2} {f}_{2} dx & ⋯ & {\int }_{{L}_{1} + {L}_{2} ⋯ {L}_{i - 1}}^{{L}_{1} + {L}_{2} ⋯ {L}_{i}} {f}_{2} {f}_{m} dx \\ ⋮ & ⋮ & ⋮ & ⋮ \\ {\int }_{{L}_{1} + {L}_{2} ⋯ {L}_{i - 1}}^{{L}_{1} + {L}_{2} ⋯ {L}_{i}} {f}_{m} {f}_{1} dx & {\int }_{{L}_{1} + {L}_{2} ⋯ {L}_{i - 1}}^{{L}_{1} + {L}_{2} ⋯ {L}_{i}} {f}_{m} {f}_{2} dx & ⋯ & {\int }_{{L}_{1} + {L}_{2} ⋯ {L}_{i - 1}}^{{L}_{1} + {L}_{2} ⋯ {L}_{i}} {f}_{m} {f}_{m} dx\end{matrix} ] .$$

10. The method of claim 1, wherein a condition for the system of the homogeneous linear equations to have a nontrivial solution in the step (8) is: a value of coefficient determinant of the system of the homogeneous linear equations is zero to obtain a frequency equation.
